(19) United States
(12) Patent Application Publication
(10) Pub. No.: US 2021/0256488 A1
(43) Pub. Date: Aug. 19, 2021

(54) FACILITATING DIGITAL ASSET TRANSACTIONS

(71) Applicant: Tonolio Carlson, St. George, UT (US)

(72) Inventor: Tonolio Carlson, St. George, UT (US)

(21) Appl. No.: 17/177,092

(22) Filed: Feb. 16, 2021

Related U.S. Application Data
(60) Provisional application No. 62/976,140, filed on Feb. 13, 2020.

(51) Int. Cl. G06Q 20/06; H04L 9/06; G06Q 20/02; G06Q 20/36

(52) U.S. Cl. CPC G06Q 20/0658; H04L 9/0643; H04L 2209/38; G06Q 20/367; G06Q 20/027

(57) ABSTRACT

Apparatuses, methods, systems, and program products are disclosed for facilitating digital asset transactions. A method includes initiating an over-the-counter (“OTC”) digital currency transaction between a user's financial institution and a digital currency exchange over a proprietary computing interface for the digital currency exchange, providing details for the OTC digital currency transaction via the proprietary computing interface, and facilitating transfer of funds between the digital currency exchange and the user's financial institution for completing the OTC digital currency transaction via the proprietary computing interface.

### CROSS-REFERENCES TO RELATED APPLICATIONS

This application claims the benefit of U.S. Provisional Patent Application No. 62/976,140 entitled “FACILITATING DIGITAL ASSET TRANSACTIONS” and filed on Feb. 13, 2020, for Tonolio Carlson, which is incorporated herein by reference.

### FIELD

This invention relates to digital assets and more particularly relates to facilitating digital asset transactions.

### BACKGROUND

Digital assets such as digital currency is a form of currency that is available only in digital or electronic form, and not in physical form. It is also called digital money, electronic money, electronic currency, or cyber cash. Digital currencies such as cryptocurrencies can be bought, sold, and traded, and/or used to make purchases.

### SUMMARY

Apparatuses, methods, systems, and program products are disclosed for facilitating digital asset transactions. A method, in one embodiment, includes initiating an over-the-counter (“OTC”) digital currency transaction between a user's financial institution and a digital currency exchange over a proprietary computing interface for the digital currency exchange, providing details for the OTC digital currency transaction via the proprietary computing interface, and facilitating transfer of funds between the digital currency exchange and the user's financial institution for completing the OTC digital currency transaction via the proprietary computing interface.

In some embodiments, the proprietary computing interface comprises a proprietary application programming interface (“API”) for the digital currency exchange. In certain embodiments, at least one of the user and the user's financial institution has been granted access to use the proprietary API for performing OTC digital currency transactions prior to initiating the OTC digital currency transaction.

In one embodiment, the method includes using previously stored electronic credentials for the at least one of the user and the user's financial institution to access the proprietary API for performing OTC digital currency transactions. In some embodiments, the OTC digital currency transaction is performed in near real-time via the proprietary API for performing OTC digital currency transactions.

In one embodiment, the method includes transferring digital assets received as part of the OTC digital currency transaction to an external digital wallet. In certain embodiments, the method includes making funds in the external digital wallet available for use as currency at merchants.

In one embodiment, the method includes performing the OTC digital currency transaction via the proprietary computing interface without user intervention. In some embodiments, the OTC digital currency transaction is performed via the proprietary computing interface without a predefined minimum trade value requirement. In one embodiment, the method includes verifying identifies of parties to the OTC digital currency transaction.

In various embodiments, the method includes transferring funds between the user's financial institution and the digital currency exchange using a blockchain wire system. In some embodiments, the method includes auditing activities involved during the OTC digital currency transaction performed via the proprietary computing interface.

An apparatus for facilitating digital asset transactions, in one embodiment, includes a processor and a memory that stores code executable by the processor to initiate an over-the-counter (“OTC”) digital currency transaction between a user's financial institution and a digital currency exchange over a proprietary computing interface for the digital currency exchange, provide details for the OTC digital currency transaction via the proprietary computing interface, and facilitate transfer of funds between the digital currency exchange and the user's financial institution for completing the OTC digital currency transaction via the proprietary computing interface.

In one embodiment, the proprietary computing interface comprises a proprietary application programming interface (“API”) for the digital currency exchange. In some embodiments, the at least one of the user and the user's financial institution has been granted access to use the proprietary API for performing OTC digital currency transactions prior to initiating the OTC digital currency transaction.

In one embodiment, the code is executable by the processor to use previously stored electronic credentials for the at least one of the user and the user's financial institution to access the proprietary API for performing OTC digital currency transactions.

In certain embodiments, the OTC digital currency transaction is performed in near real-time via the proprietary API for performing OTC digital currency transactions. In various embodiments, the code is executable by the processor to transfer digital assets received as part of the OTC digital currency transaction to an external digital wallet and make funds in the external digital wallet available for use as currency at merchants.

In some embodiments, the OTC digital currency transaction is performed via the proprietary computing interface without a predefined minimum trade value requirement.

In one embodiment, a computer program product for facilitating digital asset transactions includes a computer readable storage medium having program code embodied therein, the program code readable/executable: by a processor for initiating an over-the-counter (“OTC”) digital currency transaction between a user's financial institution and a digital currency exchange over a proprietary computing interface for the digital currency exchange, providing details for the OTC digital currency transaction via the proprietary computing interface, and facilitating transfer of funds between the digital currency exchange and the user's financial institution for completing the OTC digital currency transaction via the proprietary computing interface.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for facilitating digital asset transactions;

FIG. 2A is a schematic block diagram illustrating one embodiment of another system for facilitating digital asset transactions;

FIG. 2B is a schematic block diagram illustrating one embodiment of another system for facilitating digital asset transactions; and

FIG. 3 is a schematic flow chart diagram illustrating one embodiment of method for facilitating digital asset transactions.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to emphasize their implementation independence more particularly. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area. network (“WAN”), or the connection may be made to an external computer (for example, through the Internet using an Internet Service Provider). In some embodiments, electronic circuitry including, for example, programmable logic circuitry, field-programmable gate arrays (“FPGA”), or programmable logic arrays (“PLA”) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and computer program products according to various embodiments of the present invention. In this regard, each block in the schematic flowchart diagrams and/or schematic block diagrams may represent a module, segment, or portion of code, which comprises one or snore executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

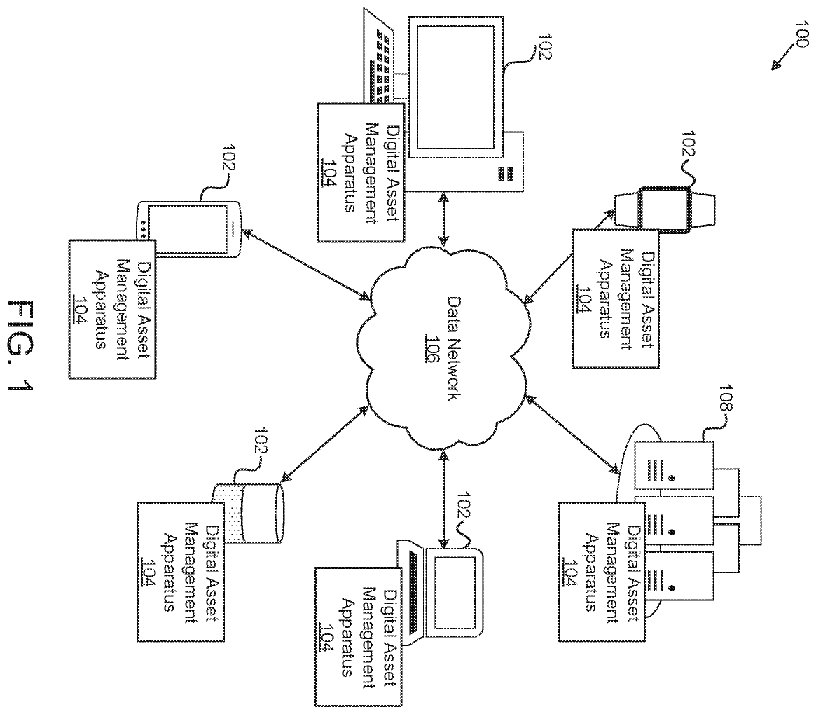

FIG. 1 is a schematic block diagram illustrating one embodiment of a system 100 for facilitating digital asset transactions. In one embodiment, the system 100 includes one or more information handling devices 102, one or more digital asset management apparatuses 104, one or more data networks 106, and one or more servers 108. In certain embodiments, even though a specific number of information handling devices 102, digital asset management apparatuses 104, data networks 106, and servers 108 are depicted in FIG. 1, one of skill in the art will recognize, in light of this disclosure, that any number of information handling devices 102, digital asset management apparatuses 104, data networks 106, and servers 108 may be included in the system 100.

In one embodiment, the system 100 includes one or more information handling devices 102. The information handling devices 102 may include one or more of a desktop computer, a laptop computer, a tablet computer, a smart phone, a smart speaker (e.g., Amazon Echo®, Google Home®, Apple HomePod®), an Internet of Things (“IoT”) device, a security system, a set-top box, a gaming console, a smart TV, a smart watch, a fitness band or other wearable activity tracking device, an optical head-mounted display (e.g., a virtual reality headset, smart glasses, or the like), a High-Definition Multimedia Interface (“HDMI”) or other electronic display dangle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium, a display, a connection to a display, and/or the like.

In one embodiment, the digital asset management apparatus 104 is configured to facilitate over-the-counter (“OTC”) transactions involving digital assets such as Bitcoin®, Ethereum®, Litecoin, Ripple, Zcash, Stellar Lumens, and/or the like. As used herein, digital assets may refer to the cryptocurrencies, such as those listed above, that comprise virtual or digital, intangible, money which takes the form of tokens or “coins.” Digital assets may be bought and sold on exchanges. For example, cryptocurrency exchanges include websites where you can buy, sell, or exchange cryptocurrencies for other digital currency or traditional currency like US dollars or Euro. Examples include Coinbase, Kraken, and/or the like.

OTC transactions at an exchange are often available fir large trades, e.g., trades involving more than $100,00.00. OTC transactions often involve a lengthy and error-prone process that includes manually speaking with a representative at an exchange to facilitate the transaction. Because human agents are involved in the trading process, there is an opportunity for errors to arise during communications and interactions between the agent and the trader while preparing and processing the transaction. Furthermore, there is an inherent security weakness by involving human agents in the trading process because the traders' financial, personal, and/or other sensitive information is available in the open and is at least visible to the agent. In addition, the manual OTC process can take hours or even days to finalize the transaction because data is manually entered and verified by the agent.

The digital asset management apparatus 104 improves upon the conventional process for facilitating OTC transactions by interfacing with an application programming interface (“API”) that is provided by an exchange, and which may be a proprietary API only offered by the exchange to certain parties, organizations, entities, and/or the like. With the use of the API, a trader can securely interface with an exchange to initiate a secure transaction/trade, provide details of the transaction/trade, and provide payment information for the transaction/trade. If purchasing digital assets, the digital asset management apparatus 104 may provide payment via a bank wire from the trader's bank to the exchange. Similarly, if selling digital assets, payment may be received via the digital asset management apparatus 104 from the purchaser's bank. In certain embodiments, use of the API allows organizations or entities to become an exchange themselves, or a digital currency trader/broker.

Due to the proprietary nature of the API, a user or financial institution may need to receive rights, privileges, grants, permissions, or the like to access, use, interface with, communicate with, and/or the like the API. For instance, a user or financial institution may need to sign up, apply for, pay for, or the like access to the API, may need to set up an account with electronic credentials such as a username and/or password, a PIN, biometric credentials, a passphase, and/or the like to access the API, and/or the like. In certain embodiments, the digital asset management apparatus 104 uses previously stored electronic credentials for the user and/or the financial institution to access or use the API for facilitating OTC transactions without user intervention, which allows for automated transactions and prevents user-induced errors (e.g., in entering credentials, data, and/or the like).

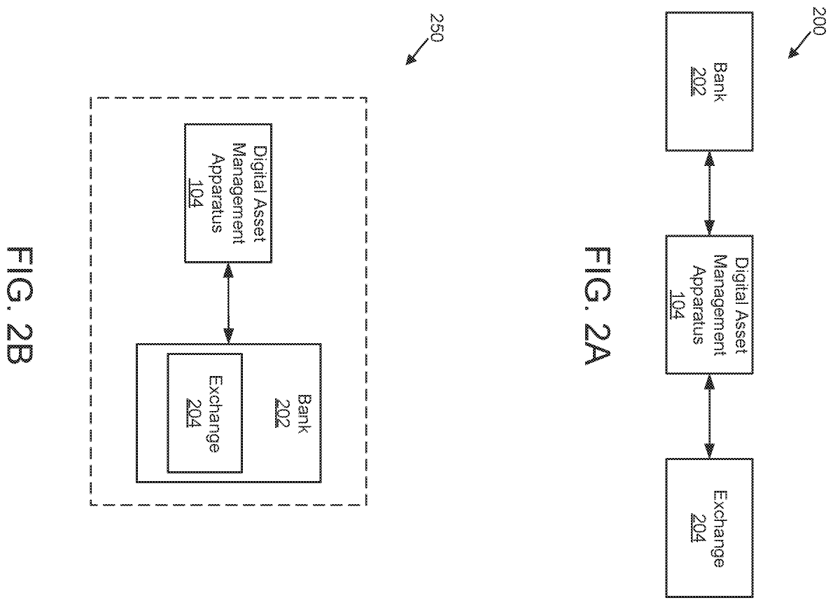

As shown in FIG. 2A, in certain embodiments, the digital asset management apparatus 104 is located between the bank 202 and the exchange 204 to facilitate transactions for a trader at the exchange 204. The digital asset management apparatus 104 may provide an interface, e.g., a website, for a trader to use to create an account, login and access their account, view their wallet (e.g., software programs that store the trader's public and private keys and interface with various blockchains to monitor balances, send money and conduct other operations), and perform various transactions and/or trades at the exchange 204 using the trader's bank account at the bank 202 to pay for buying digital assets and/or receive funds for selling digital assets.

In such a scenario, banks 202 may be in custody of the money (e.g., dollars) and not the digital assets (e.g., cryptocurrency). Accordingly, if there is ever an issue with the delivery of the digital assets, the banks 202 would not be responsible (because they are not in custody of the digital assets), hence protecting them from legal liability. Therefore, the digital asset management apparatus 104 bridges the delivery of the digital assets from the exchange 204 to the trader while facilitating payments to/from the bank 202.

In certain embodiments, the bank 202 and the exchange 204 are the same entity, as illustrated in FIG. 2B. In such an embodiment, the bank 202 has custody of the digital assets that are being traded, e.g., cryptocurrencies. Accordingly, a trader may login to their bank account and/or a separate account associated with the digital asset management apparatus 104, to perform trades and transactions using the exchange 204 that the bank 202 provides or that is otherwise part of the bank 202.

In either scenario, the exchange 204 may provide an API or other programmatic interface that applications, such as the digital asset management apparatus 104, can interface with the perform OTC trades at the exchange 104 without requiring any interaction or facilitation by a human agent. Accordingly, the digital asset management apparatus 104, together with the exchange API, provides:
immediate, real-time access to liquidity with little to no waiting time to receive purchased digital assets or funds for the sale of digital assets;
withdrawals of digital assets/cryptocurrency to an external wallet that only take 30-40 minutes;
no human errors during the process of sending the coins, setting bids/asks prices;
responsibility of placing the transactions is placed on buyer/seller and not the exchange 204 or bank 202;
no custody issues of coins to the bank 202:
no minimum trades:
Webstore/websites can accept cryptocurrency payments and receive fiat currency (e,g., U.S. Dollars) without requiring compliance with bank laws and regulations;
Users will no longer have to be registered with FinCEN as a money services business (“MSB”);
Users will not have MSB regulatory issues;
No anti-money laundering (“A IL”) reporting needed;
Bank level security to detect and prevent potential breaches and hacks; and
No need to create an account on Chats, Skype, Telegram, etc.

Furthermore, the exchange API may provide functions for verifying users (performing “know your customer” (“KYC”) functions and other background checks). Money may be transferred and received using a blockchain wire system such as Signet, which enables real-time transactions with the exchange 204 and/or with merchants/web stores. Payment may be facilitated using different secured payment methods such as cashier's checks, Western Union money order, Venmot, Paypal®, ACH, and/or the like.

The digital asset management apparatus 104, in certain embodiments, provides auditing functions such as monitoring and logging users' activities, securing/encrypting data packets between a user and a bank 202/exchange 204, tracking transactions, and/or the like. Furthermore, the digital asset management apparatus 104 allows users to transfer digital assets to an external wallet. In certain embodiments, the merchants/web stores can utilize the digital asset management apparatus 104 to receive digital assets, e.g., cryptocurrency as payment for goods/services by tying the bank 202 and the exchange 204 together along with the user's wallet/account that the digital asset management apparatus 104 manages.

Referring again to FIG. 1, in various embodiments, the digital asset management apparatus 104 may be embodied as an application, e.g., a mobile application, a website, and/or a hardware appliance that can be installed or deployed on an information handling device 102, on a server 108, on a user's mobile device, on a display, or elsewhere on the data network 106. In certain embodiments, the digital asset management apparatus 104 may include a hardware device such as a secure hardware dongle or other hardware appliance device (e.g., a set-top box, a network appliance, or the like) that attaches to a device such as a laptop computer, a server 108, a tablet computer, a smart phone, a security system, or the like, either by a wired connection (e.g., a universal serial bus (“USB”) connection) or a wireless connection (e.g., Bluetooth®, Wi-Fi, near-field communication (“NFC”), or the like); that attaches to an electronic display device e,g., a television or monitor using an HDMI port, a DisplayPort port, a Mini DisplayPort port, VGA port, DVI port, or the like); and/or the like. A hardware appliance of the digital asset management apparatus 104 may include a power interface, a wired and/or wireless network interface, a graphical interface that attaches to a display, and/or a semiconductor integrated circuit device as described below, configured to perform the functions described herein with regard to the digital asset management apparatus 104.

The digital asset management apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the digital asset management apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the digital asset management apparatus 104.

The semiconductor integrated circuit device or other hardware appliance of the digital asset management apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the digital asset management apparatus 104 includes and/or is communicatively coupled to one or more non-volatile memory media, which may include but is not limited to: NAND flash memory, NOR flash memory, nano random access memory (nano RAM or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGIobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more information handling devices 102. The servers 108 may be third-party entities that are part of the blockchain network that supports the use and exchange of digital assets.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

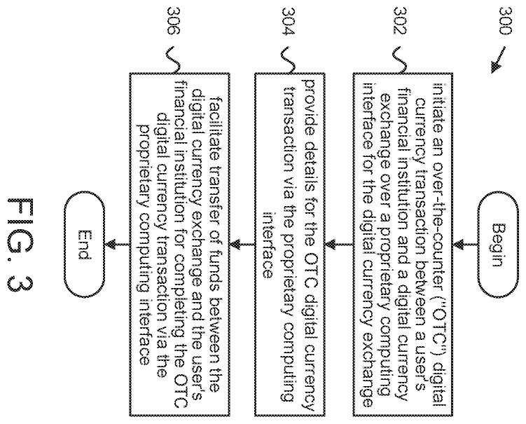

FIG. 3 is a schematic flow chart diagram illustrating one embodiment of method for facilitating digital asset transactions. In one embodiment, the method 300 begins and initiates 302 an over-the-counter (“OTC”) digital currency transaction between a user's financial institution and a digital currency exchange over a proprietary computing interface for the digital currency exchange.

In further embodiments, the method 300 provides 304 details for the OTC digital currency transaction via the proprietary computing interface. In various embodiments, the method 300 facilitates 306 transfer of funds between the digital currency exchange and the user's financial institution for completing the OTC digital currency transaction via the proprietary computing interface, and the method 300 ends. In some embodiments, the digital asset management apparatus 104 performs the various steps of the method 300.

What is claimed is:

1. A method for facilitating digital asset transactions, comprising:
initiating an over-the-counter (“OTC”) digital currency transaction between a user's financial institution and a digital currency exchange over a proprietary computing interface for the digital currency exchange;
providing details for the OTC digital currency transaction via the proprietary computing interface; and
facilitating transfer of funds between the digital currency exchange and the user's financial institution for completing the OTC digital currency transaction via the proprietary computing interface.

2. The method of claim 1, wherein the proprietary computing interface comprises a proprietary application programming interface (“API”) for the digital currency exchange.

3. The method of claim 2, wherein at least one of the user and the user's financial institution has been granted access to use the proprietary API for performing OTC digital currency transactions prior to initiating the OTC digital currency transaction.

4. The method of claim 3, further comprising using previously stored electronic credentials for the at least one of the user and the user's financial institution to access the proprietary API for performing OTC digital currency transactions.

5. The method of claim 1, wherein the OTC digital currency transaction is performed in near real-time via the proprietary API for performing OTC digital currency transactions.

6. The method of claim 1, further comprising transferring digital assets received as part of the OTC digital currency transaction to an external digital wallet.

7. The method of claim 6, further comprising making funds in the external digital wallet available for use as currency at merchants.

8. The method of claim 1, further comprising performing the OTC digital currency transaction via the proprietary computing interface without user intervention.

9. The method of claim 1, wherein the OTC digital currency transaction is performed via the proprietary computing interface without a predefined minimum trade value requirement.

10. The method of claim 1, further comprising verifying identifies of parties to the OTC digital currency transaction.

11. The method of claim 1, further comprising transferring funds between the user's financial institution and the digital currency exchange using a blockchain wire system.

12. The method of claim 1, further comprising auditing activities involved during the OTC digital currency transaction performed via the proprietary computing interface.

13. An apparatus for facilitating digital asset transactions, comprising:
a processor;
a memory that stores code executable by the processor to:
initiate an over-the-counter (“OTC”) digital currency transaction between a user's financial institution and a digital currency exchange over a proprietary computing interface for the digital currency exchange;
provide details for the OTC digital currency transaction via the proprietary computing interface; and
facilitate transfer of funds between the digital currency exchange and the user's financial institution for completing the OTC digital currency transaction via the proprietary computing interface.

14. The apparatus of claim 13, wherein the proprietary computing interface comprises a proprietary application programming interface (“API”) for the digital currency exchange.

15. The apparatus of claim 14, wherein at least one of the user and the user's financial institution has been granted access to use the proprietary API for performing OTC digital currency transactions prior to initiating the OTC digital currency transaction.

16. The apparatus of claim 15, wherein the code is executable by the processor to use previously stored electronic credentials for the at least one of the user and the user's financial institution to access the proprietary API for performing OTC digital currency transactions.

17. The apparatus of claim 13, wherein the OTC digital currency transaction is performed in near real-time via the proprietary API for performing OTC digital currency transactions.

18. The apparatus of claim 13, wherein the code is executable by the processor to transfer digital assets received as part of the OTC digital currency transaction to an external digital wallet and make funds in the external digital wallet available for use as currency at merchants.

19. The apparatus of claim 13, wherein the OTC digital currency transaction is performed via the proprietary computing interface without a predefined minimum trade value requirement.

20. A computer program product for facilitating digital asset transactions, the computer program product comprising a computer readable storage medium having program code embodied therein, the program code readable/executable by a processor for:
initiating an over-the-counter (“OTC”) digital currency transaction between a user's financial institution and a digital currency exchange over a proprietary computing interface for the digital currency exchange;
providing details for the OTC digital currency transaction via the proprietary computing interface; and
facilitating transfer of funds between the digital currency exchange and the user's financial institution for completing the OTC digital currency transaction via the proprietary computing interface.
